(19) United States
(12) Patent Application Publication
(10) Pub. No.: US 2007/0265988 A1
(43) Pub. Date: Nov. 15, 2007

(54) ARRANGEMENT AND METHOD FOR GENERATION OF A FRANKING IMPRINT

(76) Inventors: Werner Kampert, Hamburg (DE); Dirk Rosenau, Berlin (DE)

Correspondence Address: SCHIFF HARDIN, LLP;PATENT DEPARTMENT, 6600 SEARS TOWER, CHICAGO, IL, 60606-6473, US

(21) Appl. No.: 11/746,925

(22) Filed: May 10, 2007

(30) Foreign Application Priority Data
May 11, 2006 (DE) 10 2006 022 210.5

(51) Int. Cl. G06F 17/00

(52) U.S. Cl. 705/401

(57) ABSTRACT

In a method and an arrangement for generation of a franking imprint, in particular a franking machine, a base module has a printing device and a processing unit controlling the printing device for generation of the franking imprint, and a control module can be connected with the processing unit. The control module is fashioned to store and/or to generate at least one item of franking information; and the processing unit is fashioned to generate the franking imprint dependent on the franking information received from the control module. The control module can be freely connected with the processing unit by a user, and the franking information is fashioned such that it establishes at least one part of the workflow of the generation of the franking imprint.

### BACKGROUND OF THE INVENTION

1. Field of the Invention

The present invention concerns an arrangement for generation of a franking imprint (in particular a franking machine) of the type having a base module that has a printing device and a processing unit controlling the printing device for generation of the franking imprint. The control module is fashioned to store and/or to generate at least one item of franking information while the processing unit is fashioned to generate the franking imprint dependent on the franking information received from the control module. The invention furthermore concerns a corresponding method that can be used in connection with such an arrangement.

2. Description of the Prior Art

Franking machines today are normally equipped with a security module that contains the postal register with the accounting data, that effects and documents the accounting for the frankings and executes a part of the more or less complex calculations for generation of the respective franking imprint. A number of postal carriers require a portion of the printed data to be cryptographically secured, such that the security module is frequently designed with more or less complexity and is designed as a certified cryptography module.

The scope of services of the franking machine essentially mirrors the scope of services of the security module, not least for reasons of the manufacturing costs. Thus in a franking machine with a small scope of services a security module with only a small scope of services is necessary, while security modules with a greater scope of services (higher computing capacity, higher memory capacity, etc.) are typically used in higher end franking machines.

Specific postal carriers (for example the postal authorities of specific countries but also increasingly alternative postal carriers competing with the established postal carriers) require a very low degree of, if any, security of the franking imprint and/or of the accounting data, and thus need only a significantly lower scope of services of the security module, since they secure their charges in other ways. As a consequence, the security modules typically used for such an application are normally over-dimensioned with regard to their scope of services and thus are too expensive to enable an economical usage of the franking machines.

A further disadvantage of the conventional franking machines lies in that, due to the security requirements, the base module with the printing group and the security module typically form a unit that cannot be separated in an easy manner. It is typically not possible for the user of a conventional franking machine to separate the security module from the base module without impairing the functionality of the franking machine. Furthermore, conventional franking machines are typically specially configured for a specific postal carrier, not least due to the high security requirements, such that their usage is typically limited to frankings for mail items, which should be conveyed only by this postal carrier. If a conventional franking machine should be usable for a number of postal carriers, the security module would have to be configured in an elaborate manner to allow this.

### SUMMARY OF THE INVENTION

An object of the present invention is to provide an arrangement and a method for generation of a franking imprint of the aforementioned type that do not exhibit the aforementioned disadvantages or exhibit them to a lesser degree, and that in particular enable economical and flexible usage of franking machines.

The present invention is based on the insight that an economical and flexible usage of franking machines is enabled when the control module can be freely connected by a user with the processing unit and the franking information is fashioned such that it establishes at least one part of the workflow of the generation of the franking imprint. With the simple exchangeability of the control module by the user in accordance with the invention, it is possible to operate the base module with different control modules. For example, different security modules for different postal carriers can be used by a user of the franking machine. It is likewise possible for different users to use the base module with the respective security module associated with them. The usage of the franking machine is thus distinctly more flexible.

It has additionally been shown that a sufficient degree of security can be achieved with such a configuration with exchangeable control modules without driving the costs for achieving this security significantly higher.

An advantage of the usage of franking information that establishes at least parts of the generation of the franking imprint is that a very flexible design for the generation of the franking imprint (including accounting therefor) is possible, which enables a variety of different franking imprints to be generated according to, if applicable, many different methods with the same base module. It is likewise possible to implement or to control different variants of the accounting for the franking imprint.

In the simplest case the franking information can merely serve as simple switching information that establishes the use of a variant of the imprint generation (which variant is stored in the base module). Particularly in connection with the usage of the arrangement by different users for franking imprint of a single postal carrier, it is possible that only a single variant of the imprint generation is stored in the base module. The franking information then, for example, can serve merely as release information that enables the generation of a corresponding franking imprint.

In preferred variants of the inventive arrangement, the base module has a program memory for storage of at least one workflow program, the program memory being accessed by the processing unit upon generation of the franking imprint. The first processing unit is then fashioned to access the workflow program dependent on the franking information for generation of the franking imprint. As mentioned, it can thereby be provided that the franking information is fashioned such that it enables access of the first processing unit to the workflow program and therewith enables the generation of the corresponding franking imprint.

It is likewise possible that, although an imprint of the same type is always generated for different users with the same control module, different variants of the accounting for the franking imprint are implemented depending on the franking information provided via the appertaining control module. For example, it is possible for a postal carrier to award different rebates or the like to different users via the control module associated with them.

In preferred (because they offer particularly high flexibility) variants of the inventive arrangement it is provided that the program memory contains at least one first workflow program and one second workflow program. The processing unit is then fashioned to access the first workflow program or the second workflow program dependent on the franking information for generation of the franking imprint. Here as well the franking information can be used as simple switching information for switching between a first variant and a second variant of the imprint generation.

The two workflow programs can be used for different franking and/or accounting variants of a specific postal carrier. The two workflow programs can likewise be used for frankings of different postal carriers. In an embodiment of the inventive arrangement, the first workflow program is associated with the generation of a franking imprint of a first postal carrier and the second workflow program is associated with the generation of a franking imprint of a second postal carrier.

The respective workflow program can be preinstalled in the base module. In preferred (because they are particularly flexible) variants of the inventive arrangement, the processing unit is fashioned to receive a workflow program from the control module and to write it into the program memory. The design and the manufacture of the base module are thereby significantly simplified since only a minimal base program configuration is required. Furthermore, no separate updating of the base module (which is normally installed stationary) is required since such an updating ensues via the respective control module connected with the base module. Only the corresponding control modules (which are mobile anyway and thus can easily be updated in any suitable manner) must be kept in an updated state in order to be able to generate up-to-date franking imprints.

The loading of the workflow program from the control module into the program memory of the base module can ensue in any suitable manner. The loading can be initiated from both sides, i.e. both from the control module and from the base module. Furthermore, the user of the inventive arrangement may initiate the loading of the workflow program from the control module into the program memory through a corresponding input via an interface of the arrangement or the like. Preferably, however, the loading of the workflow program ensues automatically upon the occurrence of a specific, predeterminable event upon, or after the connection of the control module with the processing unit. In particular the establishment of the connection between the control module and the first processing unit can be an event that triggers the loading of the workflow program.

In further variants of the inventive arrangement the control module has a program memory for storage of at least one workflow program, the workflow program forming at least one part of the franking information. The processing unit is then fashioned to access the workflow program upon generation of the franking imprint. The expenditure for the base module thus is again significantly reduced since it must no longer have a program memory. Among other things, with regard to security against tampering, this additionally has the advantage that the program memory is housed in a control module that is normally simpler to secure logically and/or physically. No separate effort for the securing of a memory in the base module from tampering need additionally ensue.

The base module can be operated with any control module, but in other variants of the invention the base module can be operated only with specific control modules. For this purpose, the base module has a control data memory that can be connected with the processing unit, with control information being stored in the control data memory. The control information is then fashioned such that it enables access of the processing unit to the workflow program.

In this context the control information can include, for example, an identifier for a specific control module or a specific (possibly freely selectable) group of control modules (for example a specific control module type). In the course of the release it is then checked whether a predeterminable relationship (for example identity) exists between this control information and corresponding information associated with the current control module. If this is the case, the release ensues; otherwise the processing unit cannot access the workflow program of the control module.

Again, only a single workflow program need be stored in the program memory of the control module, but a number of workflow programs can likewise be located in the program memory of the control module. The control information can then establish which of the workflow programs can be accessed. Further control information can then possibly be provided (for example by the user of the arrangement) in order to establish which workflow program is accessed. It is therefore preferable for the program memory to include a first workflow program and a second workflow program, and for the first processing unit to be fashioned to access the first workflow program or the second workflow program dependent on the control information for generation of the franking imprint.

Again, the different workflow programs can be for different franking and/or accounting versions of a specific postal carrier. The different workflow programs can likewise be for frankings of different postal carriers. In an embodiment of the inventive arrangement the first workflow program is associated with the generation of a franking imprint of a first postal carrier and the second workflow program is associated with the generation of a franking imprint of a second postal carrier.

The control information can be provided in a fixed manner in the base module. In preferred (because they are particularly flexible) versions of the inventive arrangement, the base module has a specification device that can be connected with the processing unit, such as a keyboard or the like, for input of the control information.

In a preferred embodiment of the inventive arrangement, the control module includes further items of franking information. These further items of franking information can then individually or in combination represent information regarding the design of the franking imprint (for example image components of the franking imprint), information for calculation of the postage value of the franking imprint (in particular at least one postage rate table), user-specific information (for example an advertising cliche, text messages, security-relevant data such as cryptographic keys, signatures or certificates to be used, etc.), information (for example security-relevant data such as cryptographic keys, signatures or certificates to be used etc.) specific to at least one postal carrier and/or information (for example additional services, etc.) specific to at least one conveyance (transport) service. Nearly arbitrary settings or specifications for franking, inclusive of accounting therefor, can be produced.

In another embodiment of the inventive arrangement, the control module contains at least one accounting memory for storage of accounting data for a generated franking imprint. This makes it possible in a simple manner to associate the costs for the frankings generated in connection with the control module with the user of the control module. In other variants of the invention, however, the base module can exhibit a logically and/or physically secured accounting memory. Alternatively, the accounting memory itself is subject to no particular security mechanisms; but only the accounting data therein are provided in a secured manner, for example in a form secured from undetected tampering.

The control module can be freely connected with the processing unit in any suitable manner (i.e. without noteworthy hindrances). The control module is preferably fashioned such that it can be plugged in, since a particularly simple and rapid, reliable connection then is achieved.

The control module can in principle be designed in any suitable manner. The control module is preferably fashioned in the manner of a postal security module since the postal security requirements (which are typically required by governmental postal carriers) can then be satisfied in a known manner. For this purpose, the control module is preferably fashioned for implementation of cryptographic operations, in particular for encryption and/or digital signing of data. These can be cryptographic operations in connection with the communication of the components of the inventive arrangement among one another or of the inventive arrangement with other units, for example peripheral apparatuses or remote data centers. However, they can also be cryptographic operations in connection with the generation and/or accounting of the franking imprint. The control module is accordingly preferably fashioned for implementation of cryptographic operations on data of the franking imprint.

The control module can in principle be designed in any suitable manner, or be formed from any suitable components or units. The control module is preferably a smartcard since such smartcards are readily available, prefabricated, very compact units that additionally frequently already have a series of advantageous cryptographic functionalities.

The present invention furthermore concerns a method for generation of a franking imprint, in which method a processing unit has a base module that includes a printing device controlled by the processing unit for generation of the franking imprint, with which base module a control module is connected. The control module stores and/or generates at least one item of franking information. The processing unit then receives the franking information from the control module and generates the franking imprint dependent on the franking information received from the control module. According to the invention the control module can be freely connected with the base module by a user and the franking information is fashioned such that it establishes at least one part of the workflow of the generation of the franking imprint.

### DESCRIPTION OF THE DRAWINGS

FIG. 1 schematically illustrates a preferred embodiment of the inventive arrangement for generation of a franking imprint, with which a preferred embodiment of the inventive method for generation of a franking imprint can be implemented.

FIG. 2 is a flowchart of a preferred embodiment of the inventive method for generation of a franking imprint, which can be implemented with the arrangement of FIG. 1.

### DESCRIPTION OF THE PREFERRED EMBODIMENTS

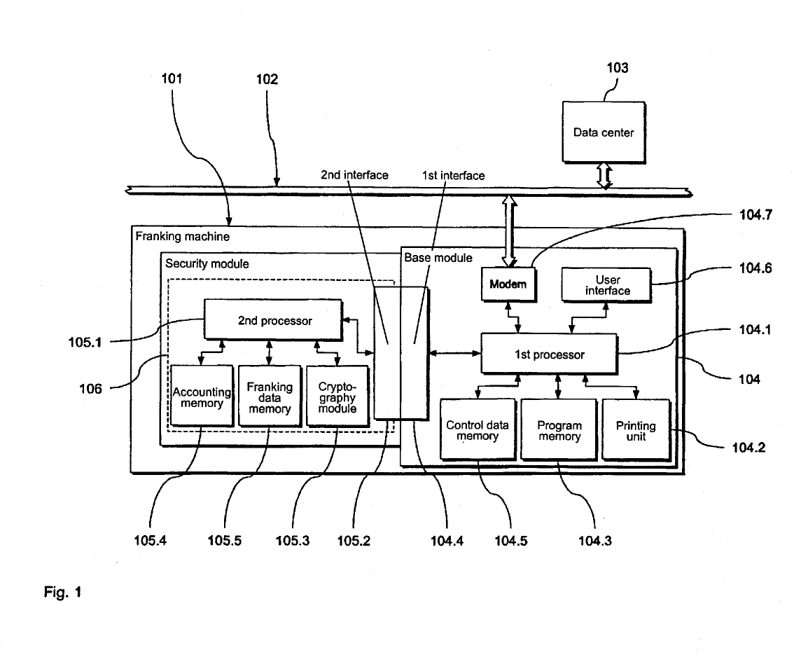

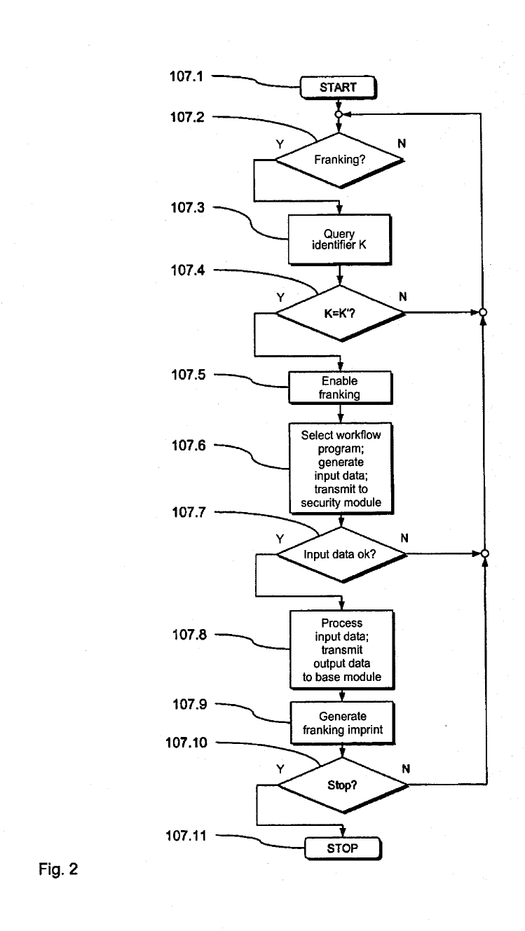

In the following a preferred embodiment of the inventive arrangement in the form of a franking machine 101 for generation of a franking imprint is initially described with reference to FIGS. 1 and 2, with which a preferred embodiment of the inventive method for generation of a franking imprint is implemented. The franking machine 101 can be connected via a communication network 102 with a remote data center 103 and has a base module 104 and a control module (in the form of a security module 105) connected therewith.

The base module 104 serves to generate the franking imprint in a typical manner. For this purpose, the base module 104 has a first processing unit in the form of a first processor 104.1 that is connected with a printing module 104.2. The processor 104.1 controls the print module 104.2 in a known manner for generation of the franking imprint on the respective mail piece. For this purpose, the first processor 104.1 accesses, among other things, a postal memory 104.3 of the base module 104 in which is stored the workflow programs required for generation of the franking imprint, and furthermore a portion of the data (for example postage tables, cliche data etc.) required for generation of the franking imprint.

The workflow program in the program memory 104.3 establishes the workflow of the data processing in the generation of the franking imprint. For this purpose, the workflow program includes, among other things, rules about the design (for example type and number of the text fields, barcodes, cliches etc.) and the content, i.e., the information content, of the franking imprint (for example information content of the text fields, barcodes etc.). Furthermore, in the present example the workflow program also establishes the type of accounting for the respective franking imprint (for example postage tables to be used, rebates, etc.). In other variants of the invention the respective workflow program can include only rules about the design and/or the content of the franking imprint or exclusively rules about the accounting of the respective franking imprint.

In the present example, among other things a first workflow program that includes the rules and data for a franking imprint of a first postal carrier is stored in the program memory 104.3. Furthermore, a second workflow program and includes the rules and data for a franking imprint of a second postal carrier is also stored in the program memory 104.3. As is explained in detail in the following, these workflow programs are accessed dependent on specific control data which establish for which postal carrier a franking imprint should be generated.

The security module 105 (connected with the base module 104 via a first interface 104.4 of the base module 104) of the franking machine 101 contains a secure processing unit in the form of a second processor 105.1 that is arranged in a secure environment 106 and is connected with the base module 104 via a second interface 105.2. The secure environment 106 provides a physical and logical securing of the second processor 105.1 from undetected, unauthorized access. The physical securing of the secure environment 106 is provided by a sealing (potting) compound in which the second processor 105.1 as well as the further components within the secure environment 106 is sealed.

The logical securing of the secure environment 106 is provided by an algorithm for checking the access authorization to the components of the security module 101. The access to the components of the security module 101 also can ensue from the outside via a second interface 105.2 connected with the second processor, the second interface 105.2 being arranged at the transition from the secure environment 106 to the region outside of the secure environment.

As soon as it is sought to access the second processor 105.1 via the second interface 105.2, this first processor 105.1 checks the access authorization of the accessing party. For this the second processor 105.1 accesses a cryptography module in the form of a memory 105.3 of the security module 101 (which memory 105.3 likewise is arranged in the secure environment 106). The cryptography module 105.3 contains (in a known manner) algorithms and data for verification of the access authorization to the security module. In the simplest case, for example, this can be a stored password which the accessing party must input in order to be authorized. It can also be a corresponding algorithm for checking digital signatures or certificates which the accessing party uses in the framework of the user's authorization.

The security module 105 serves in a typical manner to provide the security-relevant postal services (such as, for example, the secure accounting of the franking values, but also the cryptographic securing of specific postal data) required for the franking. To account for the franking values, the security module 104 has an accounting memory 105.4 that contains the register typical for a franking machine (for example ascending register, descending register etc.).

The security module 105 additionally supplies a further part of the data required for generation of the franking imprint to the first processor 104.1 in a known manner. These can be, for example, checksums, MACs, digital signatures or the like which the second processor 105.1 of the security module 105 generates over specific data of the franking imprint. In other variants of the invention with lower security requirements for the franking imprint, all data required for generation of the franking imprint are generated exclusively in the base module. In other variants of the invention with higher security requirements for the franking imprint, a majority or even all data required for generation of the franking imprint can also be generated in the security module.

The workflow of the inventive method is initially started in a step 107.1. In a step 107.2 it is then checked by the first processor 104.1 whether a franking imprint should be generated.

If a franking imprint should be generated, the base module 104 initially checks which security module is connected with it. For this purpose, in a step 107.3 the first processor 104.1 queries franking information from the security module 105, which franking information the security module 105 holds in a franking data memory 105.5 connected with the second processor 105.1. In the present example the franking information includes, among other things, an identifier K of the security module 104 which establishes which postal carrier the security module 105 is associated with, i.e. for which postal carrier franking imprints can be generated with the security module 105.

This identifier K is passed to the first processor 10.4.1 in the step 107.3 and is compared with corresponding control data K′ in a step 107.4, which corresponding control data are stored in a control data memory 104.5 of the base module 104. If a predetermined relationship exists between the identifier K and the control data K′ (here K=K′), the implementation of the franking is enabled in a step 107.5; otherwise the implementation of the franking is blocked by the first processor 104.1.

The control data in the control data memory 104.5 can thereby be provided or, respectively, set one time for subsequent frankings or for each franking, which provision or, respectively, setting is implemented by the user of the franking machine 101, for example via a user interface 104.6 of the base module 104 in the form of a keyboard, a touch-sensitive display or the like.

In other variants of the invention in which, for example, the security module is clearly associated with a specific postal carrier (for example via a corresponding coloring or other manner of identification), such a checking of the type of the security module is not implemented. In these cases the franking information passed from the security module to the base module merely includes corresponding information regarding the workflow of the generation of the franking imprint, and a franking imprint corresponding to the type of the security module is generated automatically, i.e. without further checking.

In other variants of the invention, the checking of the type of the security modules also does not need to ensue with each franking. Rather, this check can ensue only once, for example upon activation of the franking machine, and it is only monitored in a suitable manner whether a separation of the security module from the base module has occurred. If such a separation was detected, a new check of the type of the security module must then occur.

If the release of the franking occurred in the step 107.5, in a step 107.6 the first processor 104.1 initially passes corresponding input data to the second processor 105.1 via the first interface 104.4 of the base module 104 that is connected with the second interface 105.2 of the security module 105.

Upon the generation of the input data, dependent on the identifier of the security module 105 that was communicated in the step 107.4 the first processor 104.1 accesses the first or second workflow program in the program memory 104.3 that corresponds to this identifier or this type of security module. As mentioned, the appertaining workflow program thereby establishes both the content and the accounting mode for the franking imprint.

After the second processor 105.1 has checked (in the manner already described above) the authorization of the first processor 104.1 regarding the transfer of the input data, it processes these input data according to a predetermined scheme.

Among other things, in a step 107.7 the second processor 105.1 thereby checks whether the input data satisfy certain conditions. One of these conditions is that the date of the franking (which date is communicated by the base module) does not represent a date in the past, i.e. is the current date or a date in the future. For this purpose, the security module 105 can include a corresponding real time clock or another device with which the real time can be reliably determined. The security module may be synchronized with a corresponding secure real time source at predeterminable points in time or upon the occurrence of predeterminable events. The determination of the real time then can ensue, for example, by clock pulse counting (for example the timing of the second processor 105.1) or the like. To prevent tampering, the adherence to a frequency tolerance and/or the non-interrupted operation of the timing may be monitored.

If the input data do not correspond to the predetermined conditions, the franking is terminated by the security module 105 and the workflow jumps back to the step 107.2. Otherwise the second processor 105.1 generates corresponding output data in a step 107.8, which output data it then passes again to the first processor 104.1 via the interfaces 105.2 and 104.4.

In a step 107.9 the first processor 104.1 then leads the generation of the franking imprint to the end under access to the workflow program previously selected in the step 107.6, in that said first processor 104.1 controls the printing unit 104.2 in a corresponding manner after further generation and preparation of the print data.

Immediately before or after the transfer of the output data to the first processor 104.1, the second processor 105.1 generates accounting data which are used for billing the franking imprint to be generated. As in conventional franking machines, the accounting data in the accounting memory 105.4 are stored within the secure environment 106 of the security module 105.

In other variants of the invention, the accounting data can be passed to the first processor 104.1 via the interfaces 105.2 and 104.4 and can be stored by this in an accounting memory (not shown in FIG. 1, connected with the first processor 104.1) of the base module 104 (consequently thus outside of the secure environment 106) in a manner correspondingly secured against undetected manipulation. This can ensue, for example, by the second processor 105.1 of the security module providing the accounting data with a digital signature that it generates in a sufficiently known manner over at least a portion of the accounting data while accessing the cryptography module 105.3. Other known measures for securing the accounting data from undetected manipulation can also be used in other variants of the invention.

This procedure has the advantage that the security module 105 must merely provide the cryptographic functionality, but not a large (and therewith expensively secured) memory region for storage of the accounting data. Thus, the security module 105 can be designed much more cost-effectively. It is in particular possible to use a simple smartcard for the security module, which smartcard is already equipped by default with corresponding cryptographic functionality. Given such a smartcard it is then possibly only necessary to produce a corresponding physical securing as described above.

The accounting data can be generated in a form which precludes tampering. For example, a simple tampering by deletion of individual data sets can thus be precluded by providing the individual data sets of the accounting data with consecutive numbers that are likewise included in the secured part of the accounting data.

Furthermore, secured accounting data can be stored in the accounting memory 105.4 not only in the course of a franking. Rather, the accounting data in the accounting memory 105.4 naturally also include data which represent the current available credit. These data are placed in the accounting memory 105.4 in a download process in the course of a communication between the franking machine 101 and the remote data center 103 via the security module 105. The credit data can thereby already be secured in a corresponding manner by the remote data center 103. Preferably, however, the credit data transmitted from the data center 103 are initially prepared and secured in the security module 105 and only then are stored in the accounting memory 105.4.

In a step 107.10 it is then checked whether the method workflow should be ended. If this is the case, the method workflow is ended in a step 107.11. Otherwise the workflow jumps back to the step 107.2.

The first workflow program can have been entered into the program memory 104.3 in any suitable manner. In the present example the franking information in the franking data memory 105.5 of the security module 105 includes the first workflow program and the first workflow program is loaded into the program memory 104.3 as soon as the base module 104 and the security module 105 are connected with one another. This has the advantage that only the respective security modules 105 must be kept in a current state while the base module 104 can always be updated via this procedure from a corresponding secure source, namely the security module 105.

If a further security module is connected with the base module 104 which comprises a version of the second workflow program, this second workflow program is loaded into the program memory 104.3. Arbitrarily many further workflow programs can be loaded into the program memory 104.3 in this manner, possibly automatically. It is hereby understood that not every security module of the same type must necessarily have the corresponding workflow program stored. Rather, it can be provided that the franking information of specific security modules includes only the corresponding identifier of the security module type, and the base module 104 then accesses in the program memory the last workflow program loaded from a security module of this type.

In the present example the security module 105 is executed as a simple smartcard that is additionally provided further with a physical securing in the form of a sealing compound in which the components of the security module are embedded. In other variants of the invention, only the security-relevant parts of such a smartcard that are to be arranged in a secure environment are provided with a physical encapsulation, while other regions are more or less freely accessible. In this case it is only necessary to be sure that logical security is active for all possible accesses to the security-relevant components.

In the present example the security module 105 is a simple plug card that is plugged into a second interface 104.4. The second interface 104.4 is thereby freely accessible, such that any security modules 105 can be plugged in without further measures. This has the advantage that the base module 104 can possibly be freely operated in connection with a number of different security modules.

In a further preferred variant of the invention, for generation of the input data in the step 107.6 and for generation or, respectively, completion of the franking imprint in the step 107.9, the first processor 104.1 does not access a program memory 104.3 of the base module but rather accesses the workflow program that is stored in the franking data memory 105.5 of the security module 105. This access is conducted via the interfaces 104.4 and 105.2 as well as the second processor 105.1. In this case the program memory 104.3 can even be entirely absent.

In the preceding, exemplary embodiments were described in which the respective security module is associated with a single workflow program and therewith, for example, a single postal carrier. It is also possible for a security module to store a number of different workflow programs or be associated with a number of workflow programs, and the selection of the appertaining workflow program can ensue dependent on the control data in the control data memory 104.5. As mentioned above, these can possibly be predetermined by the franking machine 101 and/or the user of the franking machine 101.

Furthermore, different security modules can be configured for one and the same postal carrier, but the accounting and/or the generation of the franking imprint can ensue in a different manner (for example with different rebates, different selectable additional services, different designs of the franking imprint, etc.).

If a number of postal carriers are associated with the security module, separate regions of the accounting memory 105.4 preferably are respectively associated with each postal carrier. To simplify the association with the respective postal carrier, additionally or alternatively the accounting data can include a unique identification of the appertaining postal carrier in a region secured against manipulation. In a number of securing mechanisms this association is already possible anyway since the secret data used for securing (for example signature keys, etc.) in the security module can be unambiguously associated with the appertaining postal carrier anyway.

The memory of the security module 105 or of the base module 104 described in the preceding can be fashioned entirely or in part as separate memory modules or as individual memory regions of a single memory module.

Although modifications and changes may be suggested by those skilled in the art, it is the intention of the inventors to embody within the patent warranted hereon all changes and modifications as reasonably and properly come within the scope of their contribution to the art.

We claim as our invention:

1. An arrangement for generating a franking imprint comprising:
a base module comprising a printing device and a processing unit that controls the printing device to generate and print a franking imprint;
a control module that is freely, interchangeably manually connectable with said processing unit, said control module storing or generating at least one item of franking information that establishes at least a portion of a workflow for generating said franking imprint; and
said processing unit having access to said at least one item of franking information from said control module and generating said franking imprint dependent on said at least one item of franking information.

2. An arrangement as claimed in claim 1 wherein said base module comprises a program memory in which at least one workflow program is stored, said program memory being accessible by said processing unit for generating said franking imprint dependent on said at least one item of franking information.

3. An arrangement as claimed in claim 2 wherein said at least one item of franking information enables access of said processing unit to said workflow program.

4. An arrangement as claimed in claim 2 wherein said program memory contains a first workflow program and a second workflow program, and wherein said processing unit accesses one of said first workflow program or said second workflow program for generating said franking imprint, dependent on said at least one item of franking information.

5. An arrangement as claimed in claim 4 wherein said first workflow program is associated with generation of a franking imprint of a first postal carrier and wherein said second workflow program is associated with generation of a franking imprint of a second postal carrier.

6. An arrangement as claimed in claim 2 wherein said processing unit receives said at least one workflow program from said control module, at a time selected from the group consisting of automatically upon connection of said control module with said processing unit and after connection of said control module with said first processing unit, and writes said at least one workflow program into said program memory.

7. An arrangement as claimed in claim 1 wherein said control module comprises a program memory in which at least one workflow program is stored that forms at least a part of said at least one item of franking information, and wherein said processing unit accesses said workflow program for generating said franking imprint.

8. An arrangement as claimed in claim 7 wherein said base module comprises a control data memory connectible with said processing unit, in which control information is stored, said control information enabling access of said processing unit to said workflow program.

9. An arrangement as claimed in claim 8 wherein said base module comprises a specification device allowing manual input of said control information into said control data memory, said specification device being connected to said processing unit.

10. An arrangement as claimed in claim 7 wherein said program memory contains a first workflow program and a second workflow program, and wherein said processing unit accesses one of said first workflow program or said second workflow program for generating said franking imprint, dependent on said at least one item of franking information.

11. An arrangement as claimed in claim 10 wherein said first workflow program is associated with generation of a franking imprint of a first postal carrier and wherein said second workflow program is associated with generation of a franking imprint of a second postal carrier.

12. An arrangement as claimed in claim 1 wherein said control module contains further franking information, said further franking information being selected from the group consisting of information regarding a design of said franking imprint, information regarding calculation of a postage value in said franking imprint, a postage rate table, user-specific information, information specific to at least one mail carrier, and information specific to at least one conveyance service.

13. An arrangement as claimed in claim 1 wherein said control module comprises at least one accounting memory in which accounting data are stored associated with generation of said franking imprint.

14. An arrangement as claimed in claim 1 wherein said control module comprises a plug-in unit.

15. An arrangement as claimed in claim 1 comprising a postal security module forming said control module.

16. An arrangement as claimed in claim 1 wherein said control module implements an operation on data said operation being selected from the group consisting of a cryptographic operation on said data, encrypting said data and digitally signing said date.

17. An arrangement as claimed in claim 16 wherein said control module performs said operation on data comprising said franking imprint.

18. An arrangement as claimed in claim 1 wherein said control module is a smartcard.

19. A method for generating a franking imprint using a base module comprising a printing device and a processing unit that controls the printing device to generate and print a franking imprint, comprising the steps of:
making a control module freely, interchangeably manually connectable with said processing unit;
in said control module, storing or generating at least one item of franking information that establishes at least a portion of a workflow for generating said franking imprint; and
from said processing unit, accessing said at least one item of franking information from said control module and, in said processing unit, generating the data representing said franking imprint dependent on said at least one item of franking information.

20. A method as claimed in claim 19 wherein said base module comprises a program memory, and comprising storing at least one workflow program in said program memory and accessing said program memory from said processing unit for generating said franking imprint dependent on said at least one item of franking information.

21. A method as claimed in claim 20 wherein said at least one item of franking information enables access of said processing unit to said workflow program.

22. A method as claimed in claim 20 comprising storing a first workflow program and a second workflow program in said program memory, and comprising accessing. from said processing unit one of said first workflow program or said second workflow program for generating said franking imprint, dependent on said at least one item of franking information.

23. A method as claimed in claim 22 wherein said first workflow program is associated with generation of a franking imprint of a first postal carrier and wherein said second workflow program is associated with generation of a franking imprint of a second postal carrier.

24. A method as claimed in claim 20 comprising, from said processing unit, accessing said at least one workflow program from said control module at a time selected from the group consisting of automatically upon connection of said control module with said processing unit and after connection of said control module with said first processing unit, and writing said at least one workflow program into said program memory.

25. A method as claimed in claim 19 wherein said control module comprises a program memory, and comprising storing at least one workflow program in said program memory that forms at least a part of said at least one item of franking information and, from said processing unit, accessing said workflow program for generating said franking imprint.

26. A method as claimed in claim 25 wherein said base module comprises a control data memory connectible with said processing unit, and comprising storing control information in said control data memory and enabling access of said processing unit to said workflow program through said control information.

27. A method as claimed in claim 26 wherein said base module comprises a specification device connected to said processing unit, and comprising allowing manual input of said control information into said control data memory through said specification device.

28. A method as claimed in claim 26 comprising storing a first workflow program and a second workflow program in said program memory and, from said processing unit, accessing one of said first workflow program or said second workflow program for generating said franking imprint, dependent on said control information.

29. A method as claimed in claim 28 wherein said first workflow program is associated with generation of a franking imprint of a first postal carrier and wherein said second workflow program is associated with generation of a franking imprint of a second postal carrier.

30. A method as claimed in claim 19 comprising storing further franking information in said control module, said further franking information being selected from the group consisting of information regarding a design of said franking imprint, information regarding calculation of a postage value in said franking imprint, a postage rate table, user-specific information, information specific to at least one mail carrier, and information specific to at least one conveyance service.

31. A method as claimed in claim 19 wherein said control module comprises at least one accounting memory, and comprising storing accounting data, associated with generation of said franking imprint, in said accounting memory.

32. A method as claimed in claim 19 comprising forming said control module as a plug-in unit.

33. A method as claimed in claim 19 comprising using a postal security module as said control module.

34. A method as claimed in claim 19 comprising, in said control module, performing said operation on data comprised by said franking imprint.

35. A method as claimed in claim 19 comprising, in said control module, implementing a cryptographic operation on data said operation being selected from the group consisting of a cryptographic operation on said data, encrypting said data and digitally signing said data.

36. A method as claimed in claim 19 comprising using a smartcard as said control module.
